(19) United States
(12) Patent Application Publication
(10) Pub. No.: US 2023/0198100 A1
(43) Pub. Date: Jun. 22, 2023

(54) OFF-AXIS AND OFF-PLANE COMPLIANT BUSBAR

(71) Applicant: Our Next Energy, Inc., Novi, MI (US)

(72) Inventors: Hoa The Tran, Fountain Valley, CA (US); Nathan Schroeder, Hermosa Beach, CA (US); Gary Latham, Whitmore Lake (CA)

(21) Appl. No.: 18/085,409

(22) Filed: Dec. 20, 2022

Related U.S. Application Data
(60) Provisional application No. 63/265,936, filed on Dec. 22, 2021.

(51) Int. Cl. H01M 50/505; H01M 50/503; H01M 50/516

(52) U.S. Cl. CPC H01M 50/505; H01M 50/503; H01M 50/516; H01M 2220/20

(57) ABSTRACT

A busbar that includes a body having a first end corresponding to a first terminal contact area of the busbar, a second end opposite the first end, corresponding to a second terminal contact area of the busbar, and a spring-like middle portion located between the first end.

### TECHNICAL FIELD

The present invention relates generally to a busbar for an electric vehicle. More particularly, the present invention relates to a busbar having a spring-like middle portion that enables flexing of the busbar in a plurality of directions.

### BACKGROUND

Vehicles such as battery-electric vehicles (BEVs) and plug-in hybrid-electric vehicles (PHEVs) may have an energy storage device, such as a high-voltage battery in a battery pack assembly, that serves as the vehicle's source of propulsion. Components and systems that help manage vehicle performance and operations may be included in the battery. One or more arrays of battery cells may also be coupled electrically between battery cell terminals using intercellular connectors.

The ability to properly transmit power to the vehicle's various systems may be provided by intercellular connectors, which may comprise a system of electrical conductors for collecting and delivering current. Intercellular connectors come in a variety of forms, including wires, cables, and busbars. Busbars may feature modular designs that make installation easier and safer.

### SUMMARY

The illustrative embodiments disclose a low-profile busbar a corresponding method. In one aspect, the busbar may comprise a body including a first end corresponding to a first terminal contact area of the busbar, a second end opposite the first end, corresponding to a second terminal contact area of the busbar, and a spring-like middle portion disposed between the first end and the second end. The spring-like middle portion may have at least one bend configured as at least one depression, and at least one slit disposed transversely in the spring-like middle portion across the at least one bend. In alternative embodiments, the at least one bend may optionally be configured as at least one elevation. The at least one bend and the at least one slit may provide the spring-like middle portion with a spring-like characteristic that allows off-axis compliance of a center of the first terminal contact area relative to a center of the second terminal contact area and/or off-plane compliance of a surface of the first terminal contact area relative to a surface of the second terminal contact area. In another aspect, the at least one bend includes two or more bends. The spring-like middle portion may also comprise a same material as a material of the rest of the body, i.e., the busbar may be homogenous.

In one aspect, a method may be disclosed. The method may include providing a busbar body having a first end corresponding to a first terminal contact area of the busbar, and a second end opposite the first end, corresponding to a second terminal contact area of the busbar. The method may produce a spring-like middle portion of the busbar by creating, at least one bend configured as a depression and/or an elevation in said middle, and creating at least one transverse slit, using a first laser device, in the spring-like middle portion across the at least one bend such that said at least one bend and at least one slit provide the spring-like middle portion with a spring-like characteristic.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

To easily identify the discussion of any particular element or act, the most significant digit or digits in a reference number refer to the figure number in which that element is first introduced. Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a drivetrain and energy storage components in accordance with illustrative embodiments.

FIG. 2 depicts a diagram of a battery pack arrangement in accordance with an illustrative embodiment.

FIG. 3A depicts a perspective view of a busbar in accordance with an illustrative embodiment.

FIG. 3B depicts a perspective view of a busbar and cells in accordance with an illustrative embodiment.

FIG. 4A depicts a top view of a busbar in accordance with an illustrative embodiment.

FIG. 4B depicts a zoomed-in view of a top of a busbar in accordance with an illustrative embodiment.

FIG. 4C depicts a perspective view of a busbar in accordance with an illustrative embodiment.

FIG. 5A depicts a front view of a busbar in accordance with an illustrative embodiment.

FIG. 5B depicts a zoomed-in view of a front section of a busbar in accordance with an illustrative embodiment.

FIG. 5C depicts a zoomed-in view of a front section of a busbar in accordance with an illustrative embodiment.

FIG. 5D depicts a zoomed-in view of a front section of a busbar in accordance with an illustrative embodiment.

FIG. 6A depicts a two-dimensional view of a front of a busbar in accordance with an illustrative embodiment.

FIG. 6B depicts a two-dimensional view of a front of a busbar in accordance with an illustrative embodiment.

FIG. 6C depicts a two-dimensional view of a front of a busbar in accordance with an illustrative embodiment.

FIG. 6D depicts a two-dimensional view of a front of a busbar in accordance with an illustrative embodiment.

FIG. 6E depicts a two-dimensional view of a front of a busbar in accordance with an illustrative embodiment.

FIG. 7 depicts a perspective view of a busbar and cells in accordance with an illustrative embodiment.

FIG. 8 depicts a method in accordance with an illustrative embodiment.

### DETAILED DESCRIPTION

When compared to standard busbar sizes of batteries that deliver comparatively lower currents, busbar sizes of batteries with high current levels may be relatively larger. The material stiffness of a busbar, which is a measure of how the busbar bends under strain while still reverting to its original shape once the weight is removed, may rise as the thickness of a busbar is increased. To maintain flexibility, this may necessitate changing the fundamental structure of busbars which may result in a decline in the volumetric efficiency of the batteries. The illustrative embodiments recognize that connections between battery cells or modules can be critical components of a battery pack assembly design, affecting thermal stability, electrical protection, and volumetric energy density. Traditional intercellular connections may take up a lot of space in battery pack assemblies. When the cells dislocate even slightly during operation, for example, due to the heating and cooling of cells or vibrations of a moving vehicle combined with a lack of flexibility in the connections, connections such as wires, cables, lugs, and even conventional busbars are susceptible to failure and short circuits. The illustrative embodiments recognize that adding flexibility to busbars arbitrarily may require, depending on the design, increasing the volume occupied by the busbars in the battery pack assembly, resulting in a corresponding decrease in volumetric energy density of the battery pack assembly. Furthermore, any requirements for higher continuous current capabilities of the busbars than is standard (e.g., a continuous current carrying capacity of 220 A or more) may necessitate raising the busbar thickness, which may reduce flexibility unless accompanied by the addition of flexing means in the busbar.

The illustrative embodiments described herein are addressed to a busbar 150 engineered to be compliant in certain degrees of freedom. The busbar 150 may have a low profile that is configured to aid in the fabrication of a battery pack assembly that includes the busbar 150 having an ideal volumetric efficiency. The busbar 150 may also be used in other electrical applications beyond a battery pack busbar application. For example, the busbar 150 disclosed herein may be used in any application in which a busbar is needed. The busbar may comprise a body that has a first end corresponding to a first terminal contact area of the busbar, a second end opposite the first end, corresponding to a second terminal contact area of the busbar, and a spring-like middle portion disposed between the first end and the second end. The body may be monolithic or may comprise a plurality of stacked layers configured to support a current carrying capacity of the busbar. The spring-like middle portion may also comprise a same material as a material of the rest of the body, i.e., the busbar may be homogenous. The spring-like middle portion may be configured to provide a spring-like characteristic that allows off-axis compliance of a center of a first terminal contact area relative to a center of a second terminal contact area and/or off-plane compliance of a surface of the first terminal contact area relative to a surface of the second terminal contact area as discussed in more detail hereinafter. A method of producing and using the busbar 150 is also disclosed. Dimensions of the busbar 150 may be adjusted to accommodate not only larger currents from the cells, but also rising voltage levels. The busbar 150 may also be designed to be durable, able to withstand high levels of vibration while also providing enough rigidity to maintain the integrity of the battery pack assembly, particularly those with cell-to-pack configurations, while also being flexible enough to deal with elastic, thermal, and G-forces. Battery cells may be positioned directly into sidewalls in a cell-to-pack configuration, which may eliminate the need for separate battery modules to house the cells. The busbars may also be employed in battery modules that do not have a cell-to-pack configuration.

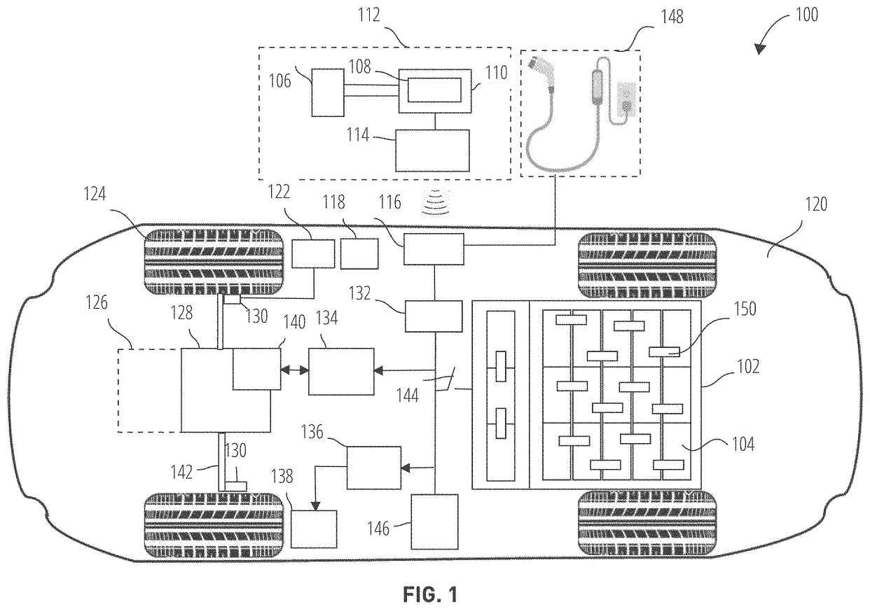

Turning to FIG. 1, a schematic of a generalized electric vehicle system 100 in which a busbar 150 of a battery pack assembly 102 may be housed will be described. It will become apparent to a person skilled in the relevant art(s) that the concepts described herein are directed to busbars used in all electrified/electric vehicles, including, but not limited to, battery electric vehicles (BEV's), plug-in hybrid electric vehicles, motor vehicles, railed vehicles, watercraft, and aircraft configured to utilize rechargeable electric batteries as their main source of energy to power their drive systems propulsion or that possess an all-electric drivetrain. Said busbars 150 may also be used in any other application in which a busbar connection that is compliant in a plurality of degrees of freedom is needed.

The electric vehicle 120 may comprise one or more electric machines 140 mechanically connected to a transmission 128. The electric machines 140 may be capable of operating as a motor or a generator. In addition, the transmission 128 may be mechanically connected to an engine 126, as in a PHEV. The transmission 128 may also be mechanically connected to a drive shaft 142 that is mechanically connected to the wheels 122. The electric machines 140 can provide propulsion and deceleration capability when the engine 126 is turned on or off. The electric machines 140 also act as generators and can provide fuel economy benefits by recovering energy that would normally be lost as heat in the friction braking system. The electric machines 140 may also reduce vehicle emissions by allowing the engine 126 to operate at more efficient speeds and allowing the electric vehicle 120 to be operated in electric mode with the engine 126 off in the case of hybrid electric vehicles.

A battery pack assembly 102 stores energy that can be used by the electric machines 140. The battery pack assembly 102 typically provides a high voltage DC output and is electrically connected to one or more power electronics modules 134. In some embodiments, the battery pack assembly 102 comprises a traction battery and a range-extender battery. Cells 104 of the battery pack assembly 102 may be electrically coupled by busbars 150 described herein. One or more contactors 144 may isolate the battery pack assembly 102 from other components when opened and connect the battery pack assembly 102 to other components when closed. To increase the energy densities available for electric vehicles, a structure of the busbars 150 is configured to eliminate unnecessary use of space as described hereinafter. The battery pack assembly may also have a cell-to-pack configuration. For example, a battery pack configuration may include cells directly placed in an enclosure without the use of separate modules, with the enclosure also housing other hardware such as, but not limited to the power electronics module 134, DC/DC converter module 136, system controller 118 (such as a battery management system (BMS)), power conversion module 132, battery thermal management system (cooling system and electric heaters) and contactors 144. By minimizing a vertical height of the busbars 150 in a pack for which high continuous current carrying capacities relative to conventional packs are needed (e.g. 220 A or more), and providing a middle portion that is allows off-axis and/or off-place compliance as described hereinafter, a consolidated arrangement is provided that allows space otherwise occupied by unusually tall offsets in the busbars to be saved and a volumetric energy density increased without sacrificing flexibility and safety provided by the busbar 150.

The power electronics module 134 is also electrically connected to the electric machines 140 and provides the ability to bi-directionally transfer energy between the battery pack assembly 102 and the electric machines 140. For example, a traction or range-extender battery may provide a DC voltage while the electric machines 140 may operate using a three-phase AC current. The power electronics module 134 may convert the DC voltage to a three-phase AC current for use by the electric machines 140. In a regenerative mode, the power electronics module 134 may convert the three-phase AC current from the electric machines 140 acting as generators to the DC voltage compatible with the battery pack assembly 102. The description herein is equally applicable to a BEV. For a BEV, the transmission 128 may be a gear box connected to an electric machine 14 and the engine 126 may not be present.

In addition to providing energy for propulsion, the battery pack assembly 102 may provide energy for other vehicle electrical systems. A typical system may include a DC/DC converter module 136 that converts the high voltage DC output of the battery pack assembly 102 to a low voltage DC supply that is compatible with other vehicle loads. Other electrical loads 146, such as compressors and electric heaters, may be connected directly to the high voltage without the use of a DC/DC converter module 136. The low-voltage systems may be electrically connected to an auxiliary battery 138 (e.g., 116V battery). The illustrative embodiments recognize that due to the numerous components that make up the drivetrain of the electric vehicle being in contact with the battery pack assembly, and heating and cooling of cells of the battery pack assembly conditions, it is desirable maximize safety and longevity of the battery pack assembly through flexible busbars while making judicious use of space to enhance volumetric efficiency.

The battery pack assembly 102 may be recharged by a charging system such as a wireless vehicle charging system 112 or a plug-in charging system 148. The wireless vehicle charging system 112 may include an external power source 106. The external power source 106 may be a connection to an electrical outlet. The external power source 106 may be electrically connected to electric vehicle supply equipment 110 (EVSE). The electric vehicle supply equipment 110 may provide an EVSE controller 108 to provide circuitry and controls to regulate and manage the transfer of energy between the external power source 106 and the electric vehicle 120. The external power source 106 may provide DC or AC electric power to the electric vehicle supply equipment 110. The electric vehicle supply equipment 110 may be coupled to a transmit coil 114 for wirelessly transferring energy to a receiver 116 of the vehicle 120 (which in the case of a wireless vehicle charging system 112 is a receive coil). The receiver 116 may be electrically connected to a charger or on-board power conversion module 138. The receiver 116 may be located on an underside of the electric vehicle 120. In the case of a plug-in charging system 148, the receiver 116 may be a plug-in receiver/charge port and may be configured to charge the battery pack assembly 102 upon insertion of a plug-in charger. The power conversion module 132 may condition the power supplied to the receiver 116 to provide the proper voltage and current levels to the battery pack assembly 102. The power conversion module 132 may interface with the electric vehicle supply equipment 110 to coordinate the delivery of power to the electric vehicle 120. The busbars 150 may provide the means to efficiently distribute power to the vehicles' various subsystems and not just the cells.

One or more wheel brakes 130 may be provided for decelerating the electric vehicle 120 and preventing motion of the electric vehicle 120. The wheel brakes 130 may be hydraulically actuated, electrically actuated, or some combination thereof. The wheel brakes 130 may be a part of a brake system 122. The brake system 122 may include other components to operate the wheel brakes 130. For simplicity, the figure depicts a single connection between the brake system 122 and one of the wheel brakes 130. A connection between the brake system 122 and the other wheel brakes 128 is implied. The brake system 122 may include a controller to monitor and coordinate the brake system 122. The brake system 122 may monitor the brake components and control the wheel brakes 130 for vehicle deceleration. The brake system 122 may respond to driver commands and may also operate autonomously to implement features such as stability control. The controller of the brake system 122 may implement a method of applying a requested brake force when requested by another controller or sub-function.

One or more electrical loads 146 may be connected to the busbars 150. The electrical loads 146 may have an associated controller that operates and controls the electrical loads 146 when appropriate. Examples of electrical loads 146 may be a heating module or an air-conditioning module.

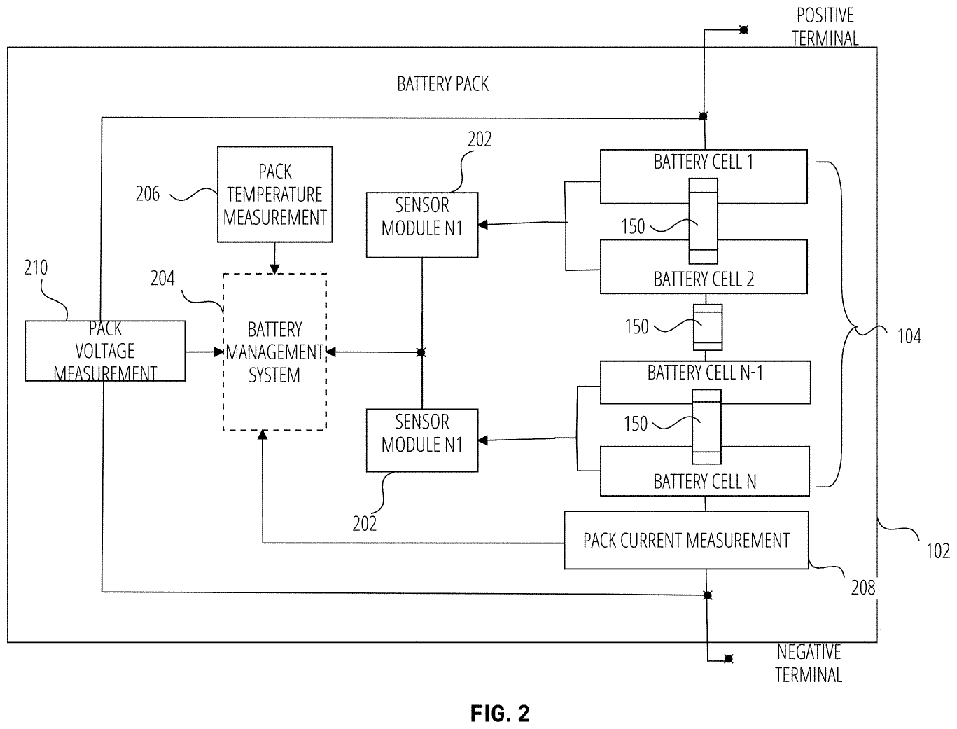

The battery pack assembly 102 may be constructed from a variety of chemical formulations, including, for example, lead acid, nickel-metal hydride (NIMH) or Lithium-Ion. FIG. 2 shows a schematic of the battery pack assembly 102 in a simple series configuration of N cells 104. Other battery pack assembly 102, however, may be composed of any number of individual battery cells connected in series or parallel or some combination thereof. The battery pack assembly 102 may have a one or more low profile, off axis and off-plane compliant busbars 150 connecting the cells 104. The battery pack assembly 102 may also have controllers such as the Battery management system (BMS 204) that monitors and controls the performance of the battery pack assembly 102. The BMS 204 may monitor several battery pack level characteristics such as pack current 208, pack voltage 210 and pack temperature 206. The BMS 204 may have non-volatile memory such that data may be retained when the BMS 204 is in an off condition. Retained data may be available upon the next key cycle.

In addition to monitoring the pack level characteristics, there may be cell 104 level characteristics that are measured and monitored. For example, the terminal voltage, current, and temperature of each cell 104 may be measured. A system may use a sensor module(s) 202 to measure the cell 104 characteristics. Depending on the capabilities, the sensor module(s) 202 may measure the characteristics of one or multiple of the cells 104. Each sensor module(s) 202 may transfer the measurements to the BMS 204 for further processing and coordination. The sensor module(s) 202 may transfer signals in analog or digital form to the BMS 204. In some embodiments, the sensor module(s) 202 functionality may be incorporated internally to the BMS 204. That is, the sensor module(s) 202 hardware may be integrated as part of the circuitry in the BMS 204 and the BMS 204 may handle the processing of raw signals.

It may be useful to calculate various characteristics of the battery pack. Quantities such a battery power capability and battery state of charge may be useful for controlling the operation of the battery pack as well as any electrical loads receiving power from the battery pack. Battery power capability is a measure of the maximum amount of power the battery can provide or the maximum amount of power that the battery can receive for the next specified time period, for example, 1 second or less than one second. Knowing the battery power capability allows electrical loads to be managed such that the power requested is within limits that the battery can handle.

Battery pack state of charge (SOC) gives an indication of how much charge remains in the battery pack. The battery pack SOC may be output to inform the driver of how much charge remains in the battery pack, similar to a fuel gauge. The battery pack SOC may also be used to control the operation of an electric vehicle. Calculation of battery pack or cell SOC can be accomplished by a variety of methods. One possible method of calculating battery SOC is to perform an integration of the battery pack current over time. Calculation of battery pack or cell SOC can also be accomplished by using an observer, whereas a battery model is used for construction of the observer, with measurements of battery current, terminal voltage, and temperature. Battery model parameters may be identified through recursive estimation based on such measurements. The BMS 204 may estimate various battery parameters based on the sensor measurements. The BMS 204 may further ensure by way of the pack current 208 that a current of the cells 104 does not exceed a defined continuous current carrying capacity of the busbars 150.

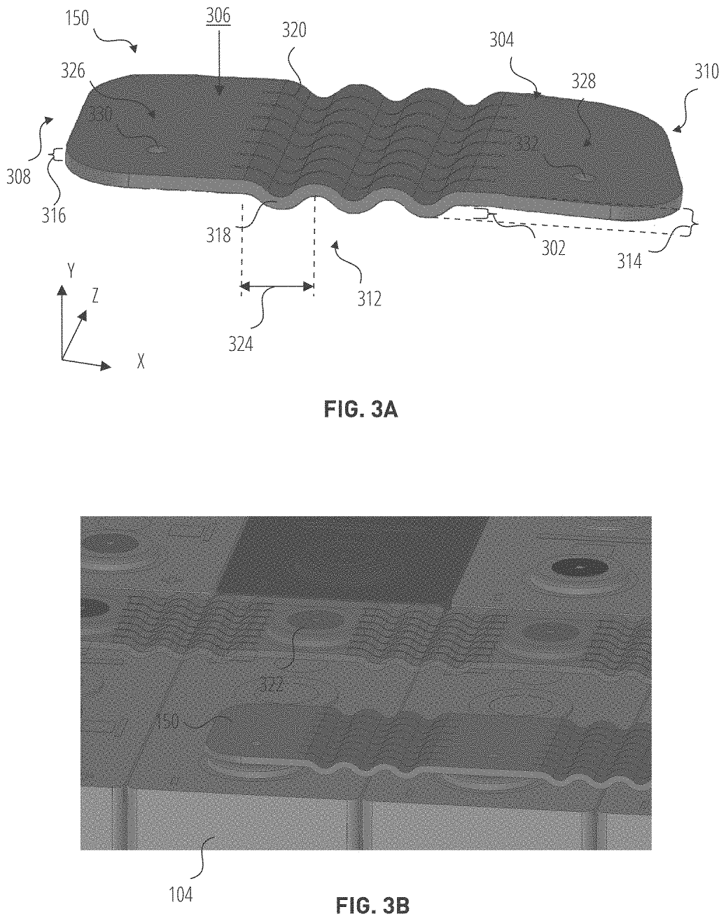

With reference to FIG. 3A, A busbar 150 having a body 304 is shown. The body 304 may comprise a first end 308 corresponding to a first terminal contact area 326 of the busbar, a second end 310 opposite the first end, corresponding to a second terminal contact area 328 of the busbar, and a spring-like middle portion 312 disposed between the first end and the second end; the spring-like middle portion having at least one bend 318 configured as a depression (as shown in FIG. 3A) and/or an elevation, and at least one cutout/slit 320 disposed transversely (in the X-direction of FIG. 3A) in the spring-like middle portion 312 across the at least one bend 318. The first terminal contact area 326 and the second terminal contact area 328 may both have a level profile 306 (level/horizontal in the X-direction with no applied pressure on the busbar 150) and may both lie in the same plane (coplanar in the XZ-plane with no applied pressure on the busbar 150). The at least one bend 318 and the at least one slit 320 may combine to provide the spring-like middle portion 312 with a spring-like characteristic that allows off-axis compliance of a center 330 of the first terminal contact area 326 relative to a center 332 of the second terminal contact area 328 and/or off-plane compliance of a surface of the first terminal contact area 326 relative to a surface of the second terminal contact area 328. Said characteristic may eliminate a need for said centers to be co-axial or for said surfaces coplanar when the surfaces are each brought, under pressure into contact with respective terminals for welding. After welding, said characteristic may furthermore enable flexing of the busbars responsive to applied forces in all directions to prevent breaking of the busbar or terminal welds. More specifically, when pressure is applied to the first terminal contact area 326 and the second terminal contact area 328 to bring said terminal contact areas into contact with the terminals of respective cells 104 prior to welding, the spring-like middle portion 312 may bend like a spring in the X, Y, and/or Z directions and may also rotate about these directions such that the first terminal contact area 326 is level with the surface of a corresponding first terminal with no air gaps or substantially no air gaps therebetween and the second terminal contact area 328 is also level with the surface area of a corresponding second terminal with no air gaps or substantially no air gaps therebetween. This may be achieved even when the level profile of the first terminal contact area (or center 330) is not on the same axis as the level profile of the second terminal contact area (or center 332) and even when the first terminal contact area is not coplanar with the second terminal contact area.

The centers 330 and 332 may also be configured as holes to enable locating of the terminals of the respective cells 104.

The slits 320 may span an entire width of the bend 318 or may span a section of the width of the bend. Further, the slits may be disposed transversely across the bend 318. However, in an embodiment, they may be disposed in any other direction, such as at an angle to the X-axis, across the bend as long as the spring nature of the spring-like middle portion 312 is maintained. Further in some illustrative embodiments, the slits 320 may not have any portions thereof disposed in the first or second terminal contact areas. A combination of different directions of the slits may also be possible. The bend may have a defined bend offset height 302 that contributes to a vertical height 314 (bend offset height 302+busbar thickness 316) of the busbar 150.

FIG. 3B shows a perspective view of the busbar 150 welded to said terminals 322 of said cells 104 in accordance with an illustrative embodiment.

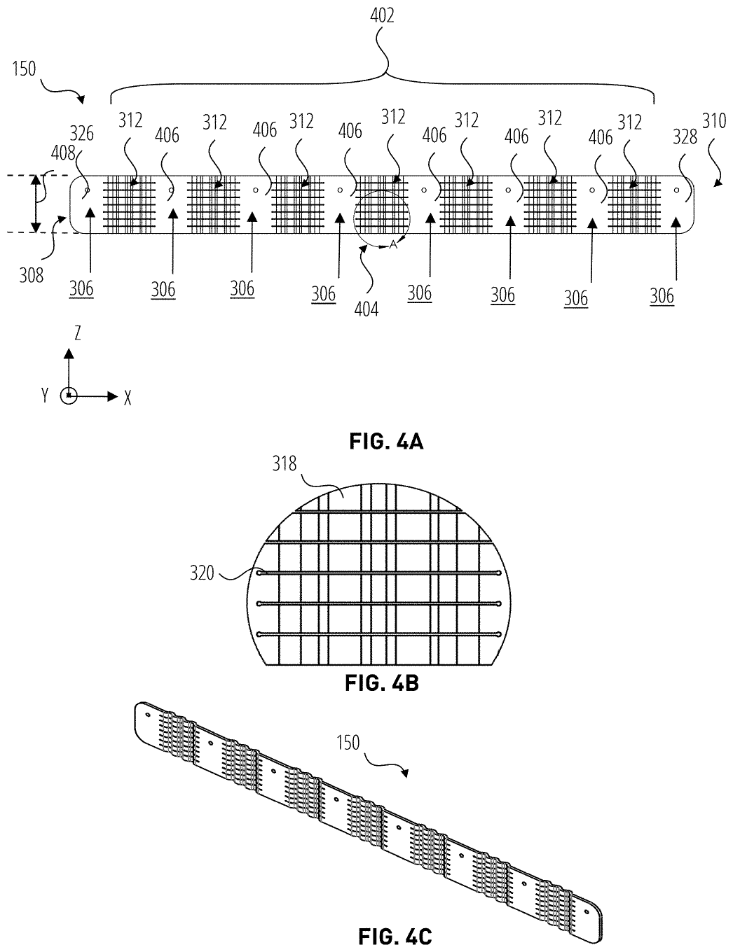

In FIG. 4A-FIG. 4C, a top view, a zoomed-in view and a perspective view of a busbar 150 are shown. The busbar 150 comprises a middle portion 402 having a plurality of spring-like middle portions 312. From this configuration, more than two terminals may be welded to the busbar 150. The busbar 150 may have one or more other terminal contact areas 406 disposed between the first terminal contact area 326 and the second terminal contact area 328. The other terminal contact areas may each have a profile that matches or substantially matches the profile of the first terminal contact area or second terminal contact area. More specifically, said other terminal contact areas 406, the first terminal contact area 326 and the second terminal contact area may all have a level profile 306 and surfaces that lie in the same plane when under no external pressure. A zoomed-in view of a first section 404 of the busbar of FIG. 4A is represented in FIG. 4B showing a plurality of slits 320 and a plurality of bends 318. Different configurations of the slits 320 and bends 318 as well as dimensions of the busbar may be realized to achieve a defined flexibility of the busbar that also withstands a defined continuous current carrying capacity of said busbar. In an illustrative embodiment, the number of slits 320 is a factor of the busbar thickness 316. The number of slits may also be a factor of a width 408 of the busbar 150. In an illustrative embodiment, the spring-like middle portion 312 of the busbar 150 may comprise at least 2 slits. The spring-like middle portion 312 may also comprise at least 7 slits per each 40 mm of width 408 of the busbar.

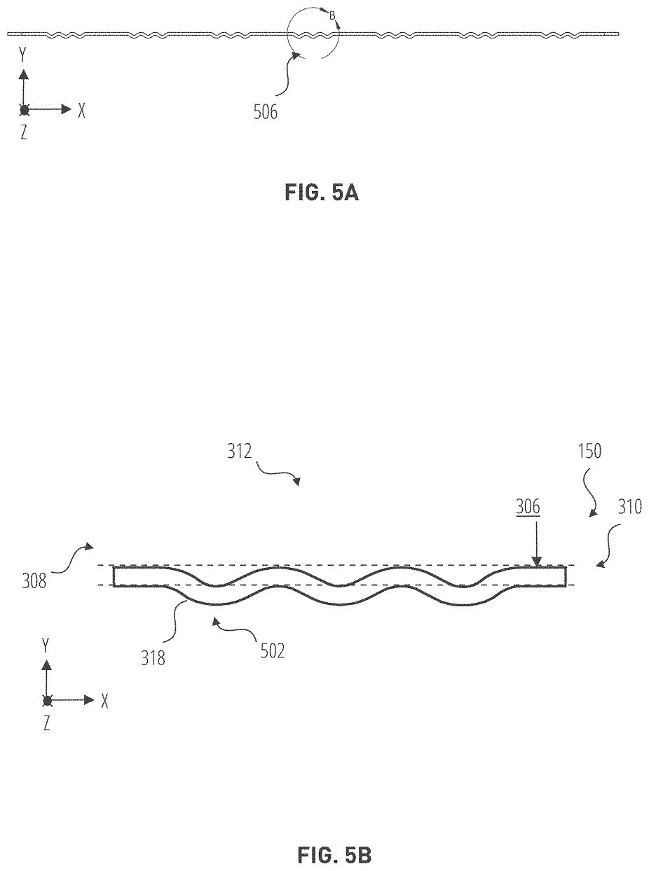

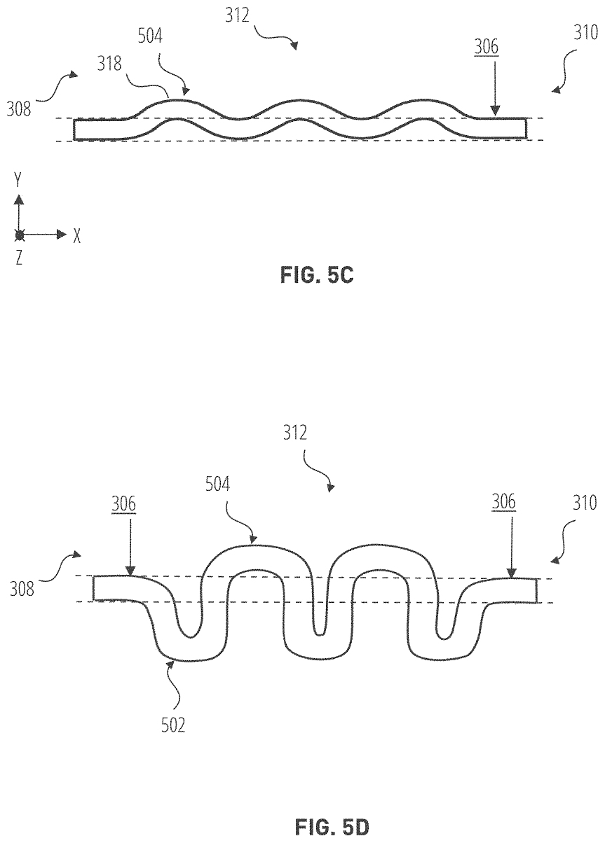

FIG. 5A illustrates a front view of a busbar 150 in accordance with an illustrative embodiment. A zoomed-in view of a second section 506 corresponding to the spring-like middle portion 312 of the busbar 150 is shown in FIG. 5B. As show in FIG. 5B, said second section 506 may have at least one bend 318 which may be designed in the form of a depression 502 that may have a depressed profile relative to the level profile 306 of the first and second terminal contact areas. In an embodiment, the at least one bend may have a radius of curvature of between 90 to 270 degrees relative to the X-axis. However, in other embodiments mechanical packaging constraints may have a higher priority as space may bey limited in the X,Y and Z directions. Alternatively, the at least one bend 318 may be configured as an elevation 504 which may have an elevated profile relative to a level profile 306 profile of the first or second terminal contact areas as shown in FIG. 5C. Even further, the at least one bend 318 of the spring-like middle portion 312 may be configured, as shown in FIG. 5D, as at least one depression 502, and at least one elevation 504 wherein each elevation 504 may be disposed adjacent to a depression 502 to provide the spring-like middle portion with a sinusoidal shape centered about the level profile 306 (i.e., bends 318 positioned both above and below the level profile 306).

According to some illustrative embodiments, the at least one bend may comprise only depressions 502 or only elevations 504 and may include two or more bends. For example, the at least one bend may comprise three bends.

According to some illustrative embodiments, the at least one bend may comprise both depressions 502 and elevations 504 and may include at least one elevation and at least one depression, such as least two elevations and at least two depressions.

Further, the busbar 150 may comprise aluminum 1100 alloy. It may also aluminum or copper (of different alloys) as the primary material choice. The body 304 of the busbar may also be dimensioned to withstand a selected continuous current carrying capacity. For example, the cross-sectional area (in the YZ-plane) of the busbar 150 may be designed to maintain a selected continuous current carrying capacity. In an illustrative example, a cross sectional area of about 50 mm² (e.g. 40-60 mm²) may be provided to maintain a continuous current carrying capacity of about 250 A (e.g., 200-300 A). Further, the number of slits may be a function of the cross-sectional area of the busbar.

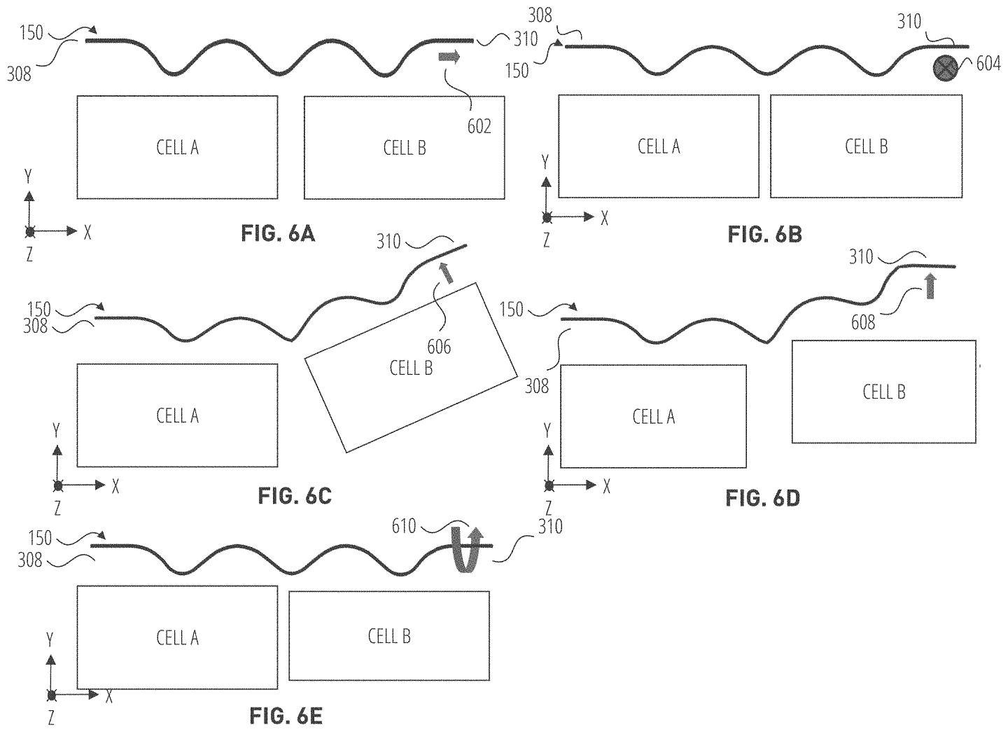

With reference to FIG. 6A—FIG. 6E, some possible movements of the spring-like middle portion 312 after welding of the busbar 150 to terminals of corresponding cells, as well as prior to welding due to pressure applied to the terminal contact areas are described in further detail. The spring-like middle portion 312 may stretch and/or twist in a plurality of directions upon receiving an applied force. As shown in FIG. 6A, a force 602 applied to a second end 310 end of the busbar 150 and may cause the busbar 150 to stretch in the X-direction to accommodate said force. The terminals of the cells may thus remain on a same axis during the stretching. However, off-axis movements may also be possible as show in FIG. 6B-FIG. 6D wherein forces 604, 606, and 608 produced by various movements such as heating and cooling of cells or produced by external pressure applied to the terminal contact areas to prepare for welding, may provide a corresponding torque on the busbar 150. To accommodate said torque, the slits 320 and bends 318 may allow at least the second end 310 busbar to move at angles to the X-axis in compliance with said forces without breaking the busbar or the terminal welds. Thus, the center 330 of the first terminal contact area 326 and the center of the second terminal contact area 328 need not be co-axial. Further, due to the spring-like nature of the spring-like middle portion 312, said spring-like middle portion 312 may twist to accommodate off-plane movements without breaking the busbar or the terminal welds. For example, as shown in FIG. 6E, force 610 may cause a torsion/twisting motion of the busbar which may be made possible by the flexible/elastic/spring-like nature of the spring-like middle portion 312. Thus, a plane in which the first terminal contact area 326 lies may be different from a plane in which the second terminal contact area 328 lies. Therefore, the busbar may possess both off-axis and off-plane compliance for said the first and second terminal contact areas. Of course, this may be equally applicable to a busbar having any number of terminal contact areas a spring-like middle portion 312 disposed between adjacent terminal contact areas. Further, by flexing (such as stretching, compressing and twisting) to accommodate cell movements from one side (e.g., from the second end 310 due to tolerances, vibration, cell growth during cycling, etc.) the busbars may minimize forces on cell terminal welds and consolidation welds (inside the cell, from electrode foils to the cell terminal) during said cell movements.

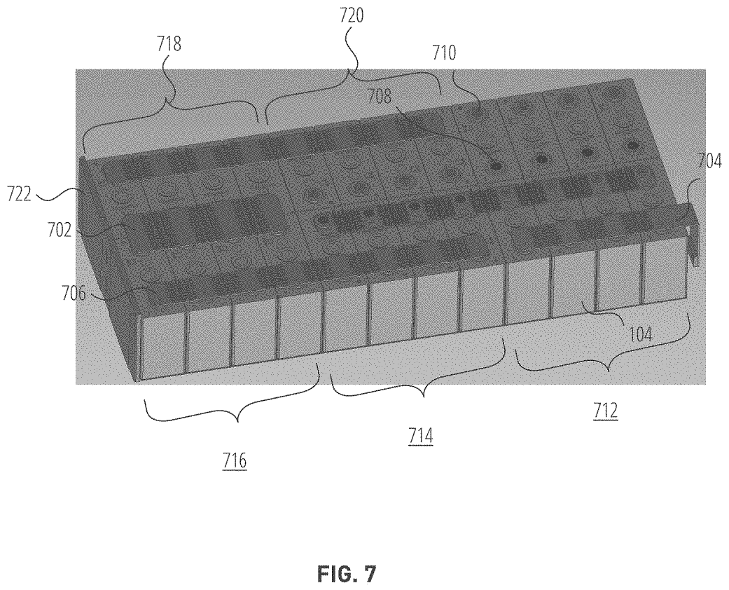

FIG. 7 illustrates a plurality of busbars 150 configured to connect a plurality of cells 104 in a cell-to-pack battery pack 722. The busbars may electrically couple the cells 104 in series or parallel combinations. Busbars 150 (e.g., end busbar 704) may also be configured to bolt a cell or group of cells (e.g., a first group of cells 712) to a fixture (not shown) for stability. The low profile of the busbars may minimize the overall package space needed for height and width of busbars. FIG. 7 shows battery pack comprising cells 104 that include a first group of cells 712, a second group of cells 714, a third group of cells 716 and a fourth group of cells 718. Second Busbar 706 may connect cell terminals of a second group of cells 714 and a third group of cells 716. Third busbar 702 may connect a third group of cells 716 in a row of the cell-to-pack battery pack 722 to a fourth group of cells 718 in a different row of the cell-to-pack battery pack 722.

In the busbar connections, the terminals may include a positive terminal 708 and/or a negative terminal 710. By welding (such as laser welding, ultrasonic welding, resistance welding) or bonding (such as chemical bonding i.e., using conductive glue/adhesives) a first side of a busbar to a negative terminal and another side to a positive terminal a first cell may be connected to another cell in a series connection as shown in. Of course, cells and busbars may be arranged in a myriad of ways to obtain series and/or parallel cell connections. Further, both positive and negative terminals of cells may typically be made of aluminum. In an embodiment, by welding a material of the busbar (such as aluminum) to a same material of the cell terminals (such as aluminum), instead of welding different materials together, the welding process to obtain a busbar-terminal weld is made easier and more efficient and the weld may be made stronger and monolithic.

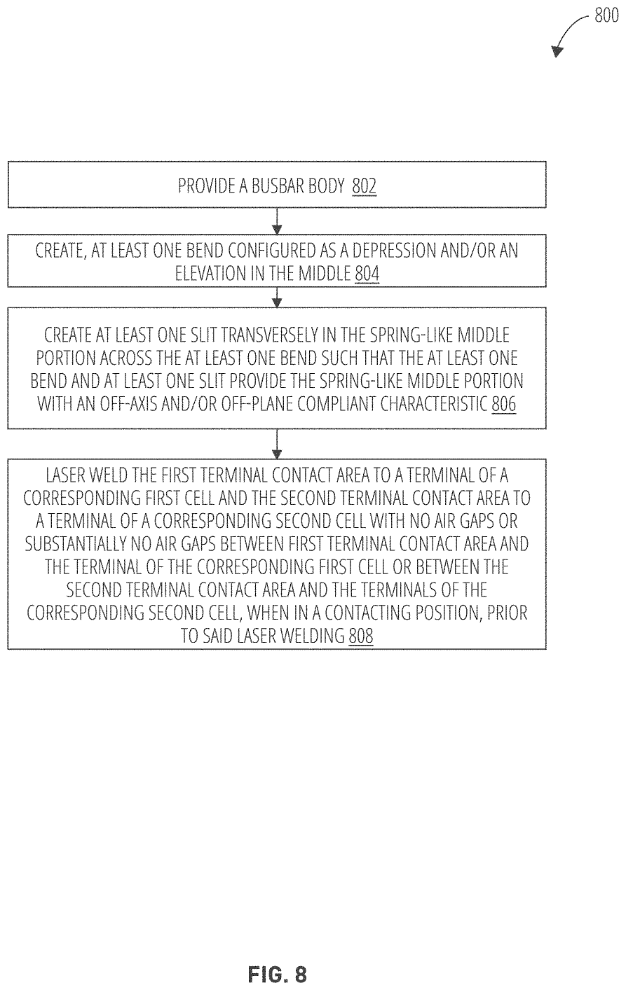

FIG. 8 illustrates a method 800 according to illustrative embodiments. In step 802, a busbar body comprising a first end corresponding to a first terminal contact area of the busbar, and a second end opposite the first end, corresponding to a second terminal contact area of the busbar is provided. In step 804, method 800 creates, at least one bend configured as a depression and/or an elevation in the middle of the busbar. In step 806, method 800 creates at least one slit or cutout, using a first laser device or other device configured to create cutouts in a solid material, transversely in the spring-like middle portion across the at least one bend such that the at least one bend and at least one slit provide the spring-like middle portion with a spring-like characteristic as described herein. In step 808, method 800 or another method prepares to weld the busbar to terminals by bringing the terminal contact areas of the busbar to terminals of respective cells using external pressure applied at the terminal contact areas. In the step, method 800 welds or bonds, using for example, a second laser device or adhesive, the first terminal contact area to a terminal of a corresponding first cell and the second terminal contact area to a terminal of a corresponding second cell while ensuring no air gaps or substantially no air gaps between first terminal contact area and the terminal of the corresponding first cell or between the second terminal contact area and the terminals of the corresponding second cell. This may be possible due to the spring-like middle portion being able to be stretched, bent or twisted to accommodate the centers of the contact areas being on different axes and the surface of the contact areas being on different planes.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A busbar comprising:
a body comprising a first end corresponding to a first terminal contact area of the busbar, a second end opposite the first end, corresponding to a second terminal contact area of the busbar, and a spring-like middle portion disposed between the first end and the second end; the spring-like middle portion having:
at least one bend configured as a depression and/or an elevation; and
at least one slit disposed transversely in the spring-like middle portion across the at least one bend;
wherein said at least one bend and at least one slit provide the spring-like middle portion with a spring-like characteristic that allows off-axis compliance of a center of the first terminal contact area relative to a center of the second terminal contact area and/or off-plane compliance of a surface of the first terminal contact area relative to a surface of the second terminal contact area.

2. The busbar of claim 1, wherein the at least one bend is configured as a depression and has a depressed profile relative to a profile of the first or second ends.

3. The busbar of claim 2, wherein the at least one bend comprises two or more bends.

4. The busbar of claim 3, wherein the at least one bend comprises three bends.

5. The busbar of claim 1, wherein the at least one bend is configured as an elevation and has an elevated profile relative to a profile of the first or second ends.

6. The busbar of claim 5, wherein the at least one bend comprises two or more bends.

7. The busbar of claim 6, wherein the at least one bend comprises three bends.

8. The busbar of claim 1, wherein the at least one bend of the spring-like middle portion comprises at least one elevation and at least one depression, and
wherein each elevation is disposed adjacent to a depression to provide the spring-like middle portion with a sinusoidal shape centered about a profile of the first or second ends.

9. The busbar of claim 8, wherein the spring-like middle portion comprises at least two elevations and at least two depressions.

10. The busbar of claim 1, wherein the spring-like middle portion comprises at least 2 slits.

11. The busbar of claim 1, wherein the number of slits is a factor of a thickness or cross-sectional area of the busbar.

12. The busbar of claim 11, wherein the body comprises a defined cross-sectional area of about 50 mm² configured to maintain a defined current carrying capacity of about 250 A.

13. The busbar of claim 1, wherein the number of slits is a factor of a width of the busbar.

14. The busbar of claim 13, wherein the spring-like middle portion comprises at least 7 slits per each 40 mm of width of the busbar.

15. The busbar of claim 1, wherein the spring-like middle portion is configured such that an air gap between the first terminal contact area and a corresponding terminal of a first cell that is brought into contact with said first terminal contact area under pressure is eliminated or substantially eliminated, and
wherein another an air gap between the second terminal contact area and a corresponding terminal of a second cell that is brought into contact with said second terminal contact area under pressure, prior to welding, is eliminated or substantially eliminated.

16. The busbar of claim 1, wherein said body comprises aluminum or copper.

17. The busbar of claim 1, wherein the at least one slits does not proceed past the first or second terminal contact areas.

18. The busbar of claim 1, further comprising:
a plurality of spring-like middle portions and a one or more other terminal contact areas disposed between the first terminal contact area and the second terminal contact area.

19. The busbar of claim 1, wherein the other terminal contact areas have a profile that matches or substantially matches the profile of the first terminal contact area or second terminal contact area.

20. The busbar of claim 1, wherein the at least one bend has a radius of curvature of between 90 and 270 degrees relative to the X-axis.

21. A method comprising:
providing a busbar body comprising a first end corresponding to a first terminal contact area of the busbar, and a second end opposite the first end, corresponding to a second terminal contact area of the busbar,
producing a spring-like middle portion of the busbar in a middle of the busbar, said spring-like middle portion being disposed between the first end and the second end by:
creating, at least one bend configured as a depression and/or an elevation in said middle; and
creating at least one slit, using a first laser device, transversely in the spring-like middle portion across the at least one bend such that said at least one bend and at least one slit provide the spring-like middle portion with spring-like characteristic that allows off-axis compliance of a center of the first terminal contact area relative to a center of the second terminal contact area and/or off-plane compliance of a surface of the first terminal contact area relative to a surface of the second terminal contact area.

22. The method of claim 21, further comprising:
welding or bonding, the first terminal contact area to a terminal of a corresponding first cell and the second terminal contact area to a terminal of a corresponding second cell with no air gaps or substantially no air gaps between the first terminal contact area and the terminal of the corresponding first cell, and between the second terminal contact area and the terminal of the corresponding second cell, when brought together under external pressure prior to said welding or bonding.
